(19) United States
(12) Patent Application Publication
(10) Pub. No.: US 2026/0164517 A1
(43) Pub. Date: Jun. 11, 2026

(54) DIMMING POWER SUPPLY

(71) Applicant: Zhuhai Shengchang Electronics Co., Ltd., Zhuhai City (CN)

(72) Inventors: Yizhou FANG, Zhuhai City (CN); Dehua ZHENG, Zhuhai City (CN)

(21) Appl. No.: 19/019,586

(22) Filed: Jan. 14, 2025

(30) Foreign Application Priority Data
Dec. 11, 2024 (CN) 2024230675096

(51) Int. Cl. H05B 45/10; H05B 45/325; H05B 45/335; H05B 45/36; H05B 45/37; H05B 45/50; H05B 47/175; H05B 47/18; H05B 47/185; H05B 47/19

(52) U.S. Cl. CPC H05B 45/10; H05B 45/325; H05B 47/183; H05B 47/184; H05B 47/185; H05B 47/19; H05B 47/196; H05B 45/335; H05B 45/36; H05B 45/37; H05B 45/50

(57) ABSTRACT

The present disclosure relates to the technical field of lighting power supply, particularly a dimming power supply, which comprises an electromagnetic filter circuit, an electric relay, a leakage protection circuit, a power supply circuit, a power factor correction circuit, a DC/DC conversion circuit, a signal conversion device, an MCU control system and a dimming device. An input end of the electromagnetic filter circuit is connected to a power supply, and an output end of the electromagnetic filter circuit is sequentially connected to a positive terminal of the light fixture load through the electric relay, the power factor correction circuit and the DC/DC conversion circuit. An output end of the leakage protection circuit is connected to a coil of the electric relay, and the leakage protection circuit is connected to the output end of the electromagnetic filter circuit through the power supply circuit.

### TECHNICAL FIELD

The present disclosure relates to the technical field of lighting power supply, particularly a dimming power supply.

### BACKGROUND

With the continuous progress of society and the rapid development of information technology, people's living standards have steadily improved, along with an increasing demand for personalized lighting environments. Compared to low-voltage LED strip lights, high-voltage LED strip lights have a higher input voltage, which results in a lower voltage drop over the same wiring distance, making them more suitable for long-distance wiring. However, traditional high-voltage LED strip lights require a single input and output voltage and, therefore are not compatible with the residential and industrial electricity standards of most regions worldwide. This forces manufacturers to stock an excessive number of dimming power supply products with different parameters. Moreover, the existing high-voltage LED power supplies commonly lack support for dimming and color temperature control, preventing the realization of personalized colorful lighting settings. Furthermore, due to the lack of leakage protection, these power supplies are prone to damaging the light fixtures in the event of extreme electrical leakage.

### SUMMARY

To overcome the deficiencies in the prior art, the present disclosure aims to provides a dimming power supply that is capable of outputting multiple voltage specifications to accommodate different high-voltage LED strip lights, and features leakage protection to enhance safety during use.

To solve the aforementioned problems, the technical solution adopted by the present disclosure is as follows: A dimming power supply, comprising: an electromagnetic filter circuit, an electric relay, a leakage protection circuit, a power supply circuit, a power factor correction circuit, a DC/DC conversion circuit, a signal conversion device, an MCU control system and a dimming device; wherein an input end of the electromagnetic filter circuit is connected to a power supply; the electric relay is connected between an output end of the electromagnetic filter circuit and an input end of the power factor correction circuit; an output end of the power factor correction circuit is connected to a positive terminal of a light fixture load through the DC/DC conversion circuit; an output end of the leakage protection circuit is connected to a coil of the electric relay; the leakage protection circuit is connected to the output end of the electromagnetic filter circuit or the power supply through the power supply circuit; the MCU control system is connected to a dimming signal receiving device; the MCU control system is connected to an output end of the electric relay through the signal conversion device; the MCU control system is connected to a negative terminal of the light fixture load through the dimming device; and the MCU control system is connected to a control end of the DC/DC conversion circuit.

Compared to the prior art, the present disclosure offers several advantages: the leakage protection circuit is capable of detecting any leakage current in the lighting apparatus. Upon detecting leakage, it controls the electric relay to disconnect the power supply to the light fixture load, thereby ensuring the safety of both the power supply and the light fixture. The MCU control system can receive voltage control signals carried by the input AC voltage through a signal conversion circuit. By controlling the DC/DC conversion circuit, it adjusts the output voltage to the light fixture load, accommodating high-voltage LED strip lights with various specifications and parameters. The electromagnetic filter circuit reduces electromagnetic interference (EMI) from the power supply to surrounding electrical devices, as well as from external devices to the power supply, enabling the power supply to meet EMI standards in different regions. The dimming power supply features a wide range of input and output voltages, high adaptability, and excellent safety during operation.

For the aforementioned dimming power supply, the dimming device includes a plurality of dimming circuits.

For the aforementioned dimming power supply, the signal conversion device comprises a phase-controlled chopper signal conversion circuit and/or a power line carrier signal conversion circuit.

For the aforementioned dimming power supply, the dimming signal receiving device comprises a wired control signal receiving circuit and/or a wireless control signal receiving circuit.

For the aforementioned dimming power supply, the wired control signal receiving circuit comprises at least one of a digitally addressable lighting interface (DALI) signal receiving circuit, a digital multiplex (DMX) signal receiving circuit, a 0-10V signal receiving circuit, a 1-10V signal receiving circuit, a 10V pulse-width modulation (PWM) signal receiving circuit and an adjustable resistance signal receiving circuit.

For the aforementioned dimming power supply, the wireless control signal receiving circuit comprises at least one of a ZigBee device, a 433 Mhz device, a near field communication (NFC) device, a Bluetooth device and a Wifi device.

For the aforementioned dimming power supply, the dimming power supply further comprises a peripheral device, and the peripheral device is connected to the MCU control system.

For the aforementioned dimming power supply, the peripheral device comprises at least one of a toggle switch, an adjustable resistor, a rotary potentiometer, an encoder potentiometer and a temperature sensor.

The present disclosure is further described in detail below with reference to the accompanying drawings and specific embodiments.

### BRIEF DESCRIPTION OF THE DRAWINGS

FIG. 1 is a schematic block diagram of the dimming power supply according to an embodiment of the present disclosure.

### DETAILED DESCRIPTION OF THE EMBODIMENTS

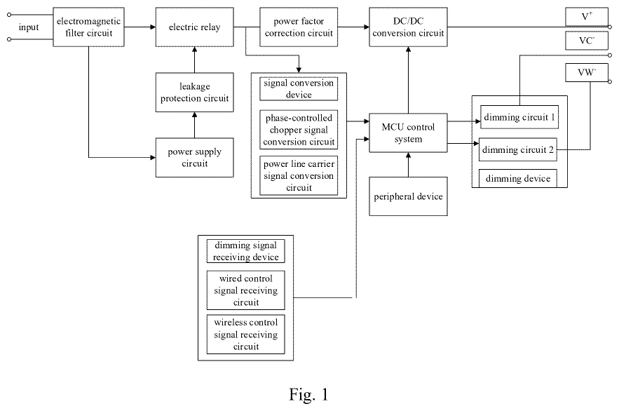

Embodiments of the present disclosure are described in detail below. With reference to FIG. 1, an embodiment of the present disclosure provides a dimming power supply, comprising an electromagnetic filter circuit, an electric relay, a leakage protection circuit, a power supply circuit, a power factor correction circuit, a DC/DC conversion circuit, a signal conversion device, an MCU control system and a dimming device. An input end of the electromagnetic filter circuit is connected to a power supply; the electric relay is connected between an output end of the electromagnetic filter circuit and an input end of the power factor correction circuit; and an output end of the power factor correction circuit is connected to a positive terminal of a light fixture load through the DC/DC conversion circuit. The power factor correction circuit is used to improve the input current waveform, enhance the power factor, reduce harmonic injection into the grid, stabilize the output voltage, and improve the quality of output power. This allows for compatibility with a wide range of input voltages and ensures that the high voltage output to the DC/DC conversion circuit remains stable. An output end of the leakage protection circuit is connected to a coil of the electric relay. The leakage protection circuit is connected to the output end of the electromagnetic filter circuit through the power supply circuit, obtaining the electrical energy required for its operation from the rectified DC output of the electromagnetic filter circuit. It is understandable that in some embodiments, the electrical energy required for the operation of the leakage protection circuit can also be directly obtained from the input power source through the power supply circuit. The electromagnetic filter circuit reduces electromagnetic interference (EMI) from the power supply to surrounding electrical devices, as well as from external devices to the power supply, enabling the power supply to meet EMI standards in different regions. The leakage protection circuit is used to detect whether there is any leakage current in the lighting apparatus, and upon detecting such leakage, it controls the electric relay to disconnect, thereby providing leakage protection for both the power supply and the light fixture load. The MCU control system is connected to a dimming signal receiving device; the MCU control system is connected to an output end of the electric relay through the signal conversion device; the MCU control system is connected to a negative terminal of the light fixture load through the dimming device; and the MCU control system is connected to a control end of the DC/DC conversion circuit. The MCU control system recognizes the dimming signals input through the input line via a signal conversion device, or receives external dimming signals through a dimming signal receiving device. Based on these dimming signals, it controls the DC/DC conversion circuit and the dimming device to operate, providing an appropriate output voltage to the light fixture load and enabling the lighting apparatus to produce the desired lighting effect for the user.

This dimming power supply features a wide input and output voltage range, making it compatible with household and industrial electrical standards in most regions of the world. It can adapt to high-voltage LED strips with different input voltage specifications and meet the electromagnetic interference standards of various regions. This reduces the variety of power supplies that customers need to stock, lowers production costs, and enhances safety through the leakage protection circuit that protects the light fixture load from leakage. Additionally, this dimming power supply can not only recognize dimming signals carried on the input line via a signal conversion device but also receive external dimming signals through a dimming signal input device, facilitating the intelligent transformation of lighting circuits. It is understood that the specific structures of the electromagnetic filter circuit, leakage protection circuit, power supply circuit, and DC/DC conversion circuit are common knowledge in the art and will not be elaborated here.

Referring to FIG. 1, in the embodiment, the signal conversion device comprises a phase-controlled chopper signal conversion circuit or a power line carrier signal conversion circuit, depending on the method used to superimpose the dimming signal onto the voltage of the input line. The specific structures of the phase-controlled chopper signal conversion circuit and the power line carrier signal conversion circuit are common knowledge in the art and will not be elaborated here.

Referring to FIG. 1, in the embodiment, the dimming device comprises a plurality of dimming circuits, which can be used separately for adjusting color temperature and brightness, or for adjusting the brightness and color temperature of a plurality of different colored LEDs in a color LED strip, thereby driving the LED strip to achieve various lighting effects and allowing users to set more personalized color effects. The dimming circuit can be a metal-oxide semiconductor (MOS) tube drive circuit, such as a PWM drive circuit, which receives the PWM control signal output by the MCU control system and adjusts the conduction time of the MOS tube by modifying the duty cycle of the PWM control signal, thus achieving adjustment of the color temperature or brightness of the lighting apparatus.

Referring to FIG. 1, in this embodiment, to enable the dimming power supply to be compatible with more dimming control methods, the dimming signal receiving device comprises a wired control signal receiving circuit and/or a wireless control signal receiving circuit. It is understood that the wired control signal receiving circuit can be one or several of the common wired dimming signal methods such as a DALI signal receiving circuit, a DMX signal receiving circuit, a 0-10V signal receiving circuit, a 1-10V signal receiving circuit, a 10V PWM signal receiving circuit and an adjustable resistance signal receiving circuit. The wireless control signal receiving circuit can include various wireless communication devices such as a ZigBee device, a 433 Mhz device, a NFC device, a Bluetooth device and a Wifi device.

In some embodiments, the dimming power supply can also comprise a peripheral device, and the peripheral device is connected to the MCU control system. The peripheral device is used for more precise adjustment of parameters such as the output voltage, output current, and output frequency of the dimming power supply to accommodate more types of light fixture loads and achieve a wider variety of dimming effects. The peripheral device can comprise input peripheral devices such as a toggle switch, an adjustable resistor, a rotary potentiometer, an encoder potentiometer, a keyboard and a touchscreen. In some embodiments, the peripheral device can also comprise sensors such as a temperature sensor to monitor the temperature and other states of the light fixture load, facilitating more intelligent closed-loop control of the light fixture load based on its temperature and ensuring the stability of its operation.

It should be noted that, in the description of the present disclosure, any references to orientation, such as “up”, “down”, “front”, “back”, “left”, “right”, etc., are based on the orientation or positional relationships depicted in the accompanying drawings. These references are solely for the convenience of describing the present disclosure and simplifying the description. They do not indicate or imply that the device or element referred must have a specific orientation, be constructed or operated in a particular orientation, and should not be construed as a limitation of the present disclosure.

In the description of the present disclosure, “a plurality of” shall refer to one or more, “multiple” shall refer to two or more, and expressions such as “greater than,” “less than,” “exceed,” etc., shall be understood as excluding the stated number. Expressions such as “above,” “below,” “within,” etc., shall be understood as including the stated number. If references to “first” or “second” are made, they are merely for the purpose of distinguishing technical features, and should not be understood to indicate or imply relative importance, or implicitly specify the number of technical features being referred to, or imply any order of precedence among the technical features.

In the description of the present disclosure, unless otherwise explicitly limited, words such as “provided with”, “install”, and “connect” should be understood in a broad sense. Those skilled in the art can reasonably determine the specific meaning of the above words in the present disclosure in combination with the specific content of the technical solution.

The aforementioned embodiments are only preferred embodiments of the present disclosure and cannot be used to limit the scope of protection of the present disclosure. Any non-substantive changes and substitutions made by those skilled in the art on the basis of the present disclosure shall belong to the scope of protection claimed by the present disclosure.

What is claimed is:

1. A dimming power supply, comprising: an electromagnetic filter circuit, an electric relay, a leakage protection circuit, a power supply circuit, a power factor correction circuit, a DC/DC conversion circuit, a signal conversion device, an MCU control system and a dimming device; wherein an input end of the electromagnetic filter circuit is connected to a power supply; the electric relay is connected between an output end of the electromagnetic filter circuit and an input end of the power factor correction circuit; an output end of the power factor correction circuit is connected to a positive terminal of a light fixture load through the DC/DC conversion circuit; an output end of the leakage protection circuit is connected to a coil of the electric relay; the leakage protection circuit is connected to the output end of the electromagnetic filter circuit or the power supply through the power supply circuit; the MCU control system is connected to a dimming signal receiving device; the MCU control system is connected to an output end of the electric relay through the signal conversion device; the MCU control system is connected to a negative terminal of the light fixture load through the dimming device; and the MCU control system is connected to a control end of the DC/DC conversion circuit.

2. The dimming power supply according to claim 1, wherein the dimming device includes a plurality of dimming circuits.

3. The dimming power supply according to claim 1, wherein the signal conversion device comprises a phase-controlled chopper signal conversion circuit and/or a power line carrier signal conversion circuit.

4. The dimming power supply according to claim 1, wherein the dimming signal receiving device comprises a wired control signal receiving circuit and/or a wireless control signal receiving circuit.

5. The dimming power supply according to claim 4, wherein the wired control signal receiving circuit comprises at least one of a digitally addressable lighting interface (DALI) signal receiving circuit, a digital multiplex (DMX) signal receiving circuit, a 0-10V signal receiving circuit, a 1-10V signal receiving circuit, a 10V pulse-width modulation (PWM) signal receiving circuit and an adjustable resistance signal receiving circuit.

6. The dimming power supply according to claim 4, wherein the wireless control signal receiving circuit comprises at least one of a ZigBee device, a 433 Mhz device, a near field communication (NFC) device, a Bluetooth device and a Wifi device.

7. The dimming power supply according to claim 1, further comprising a peripheral device, and the peripheral device is connected to the MCU control system.

8. The dimming power supply according to claim 7, wherein the peripheral device comprises at least one of a toggle switch, an adjustable resistor, a rotary potentiometer, an encoder potentiometer and a temperature sensor.
